(19) United States
(12) Patent Application Publication
(10) Pub. No.: US 2013/0139772 A1
(43) Pub. Date: Jun. 6, 2013

(54) FLUID BRAKE DEVICE AND VALVE TIMING CONTROLLER

(71) Applicant: DENSO CORPORATION, Kariya-city (JP)

(72) Inventors: Youhei KAMIYA, Chiryu-city (JP); Seiichiro WASHINO, Nagoya-city (JP); Toru TAKAHASHI, Chiryu-city (JP)

(73) Assignee: DENSO CORPORATION, Kariya-city (JP)

(21) Appl. No.: 13/690,399

(22) Filed: Nov. 30, 2012

(30) Foreign Application Priority Data
Dec. 1, 2011 (JP) 2011-263917

(51) Int. Cl. F16D 57/00; F01L 1/344

(52) U.S. Cl. CPC F16D 57/002; F01L 1/344
USPC 123/90.17; 188/267.2

(57) ABSTRACT

A fluid brake device includes a case defining a fluid chamber filled with magnetorheological fluid, a brake rotor having a magnetic part received in the fluid chamber, a coil that generates magnetic flux by being supplied with electricity, and a controller that controls electricity supplied to the coil. Magnetic particles are suspended in the magnetorheological fluid, and the magnetic flux passes through the magnetic part. The controller continues supplying the electricity to the coil while the brake rotor has a half rotation from a stop state where the brake rotor is stopped at a startup time at which the brake rotor starts rotating.

### CROSS REFERENCE TO RELATED APPLICATION

This application is based on Japanese Patent Application No. 2011-263917 filed on Dec. 1, 2011, the disclosure of which is incorporated herein by reference in its entirety.

### TECHNICAL FIELD

The present disclosure relates to a fluid brake device and a valve timing controller having the fluid brake device.

### BACKGROUND

A fluid brake device has a case defining a fluid chamber inside, magnetorheological fluid which is filled in the fluid chamber, and a brake rotor contacting the magnetorheological fluid. Viscosity of the magnetorheological fluid is varied when a magnetic flux generated by a coil passes through the magnetorheological fluid. The brake rotor in the rotation state receives a braking torque in accordance with a variation in the viscosity of the magnetorheological fluid.

The braking torque can be given to the brake rotor with comparatively small electric power, so the fluid brake device is suitably used for a valve timing controller that controls a valve timing of an internal combustion engine by changing a relative rotational phase between a crankshaft and a camshaft according to the braking torque.

JP-2010-121614A (US 2010/0095920) describes such a fluid brake device in which a magnetic part (rotor part) of a brake rotor is received in a fluid chamber filled with magnetorheological fluid. Magnetic particles are suspended in the magnetorheological fluid. Magnetic flux generated by a coil passes through the fluid chamber and the magnetic part. If the magnetic particles are uniformly adsorbed on the magnetic part in a rotation direction of the brake rotor, the braking torque can be stably given to the brake rotor, and the brake performance is restricted from being varied.

However, after the brake rotor is stopped for a long time, the magnetic particles contained in the magnetorheological fluid stay in the lower area of the fluid chamber as sediments. If the magnetic particles are adsorbed in non-uniform state in the rotation direction at the startup time or immediately after the brake rotor starts rotating, the braking torque given to the brake rotor becomes unstable, and the brake performance may be lowered.

### SUMMARY

According to an example of the present disclosure, a fluid brake device includes a coil, a magnetorheological fluid, a case, a brake rotor and a controller. The coil generates magnetic flux by being supplied with electricity. The magnetorheological fluid, in which magnetic particles are suspended, has a viscosity that is varied by the magnetic flux passing through the magnetorheological fluid. The case defines a fluid chamber that is filled with the magnetorheological fluid. The brake rotor has a magnetic part received in the fluid chamber, and the magnetic flux passes through the magnetic part. The brake rotor receives a braking torque in accordance with a variation in the viscosity of the magnetorheological fluid that contacts the magnetic part while the brake rotor rotates. The controller controls the electricity supplied to the coil. The controller continues supplying the electricity to the coil while the brake rotor has a half rotation from a stop state where the brake rotor is stopped at a startup time at which the brake rotor starts rotating.

According to an example of the present disclosure, a valve timing controller that controls a valve timing of a valve opened and closed by a camshaft based on a torque transmitted from a crankshaft in an internal combustion engine includes the fluid brake device and a phase adjusting mechanism connected to the brake rotor. The phase adjusting mechanism controls a relative rotational phase between the crankshaft and the camshaft according to the braking torque input into the brake rotor. The controller of the fluid brake device controls the electricity supplied to the coil in a manner that the relative rotation phase is controlled within a predetermined allowable phase range which allows a startup of the internal combustion engine when the brake rotor starts rotating together with the crankshaft and the camshaft.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-sectional view illustrating a valve timing controller having a fluid brake device according to an embodiment, the cross-sectional view being taken along a line I-I of FIG. 2;

FIG. 2 is a cross-sectional view taken along a line II-II of FIG. 1;

FIG. 3 is a cross-sectional view taken along a line III-III of FIG. 1;

FIG. 4 is a graph illustrating a relationship between a density of magnetic flux and a viscosity of magnetorheological fluid in the fluid brake device;

FIG. 5 is a schematic cross-sectional view illustrating the fluid brake device in the stop state;

FIG. 6 is a schematic cross-sectional view illustrating the fluid brake device in which magnetic flux passes through magnetorheological fluid;

FIG. 7 is a schematic cross-sectional view illustrating the fluid brake device after a brake rotor of the fluid brake device is rotated by a half rotation;

FIG. 8 is a schematic cross-sectional view illustrating the fluid brake device in which the magnetic flux is stopped from passing through the magnetorheological fluid;

FIG. 9 is a graph illustrating a relationship between a time and a current of a pulse applied to a coil of the fluid brake device; and

FIG. 10 is a flowchart illustrating a startup mode executed by a control circuit of the fluid brake device.

### DETAILED DESCRIPTION

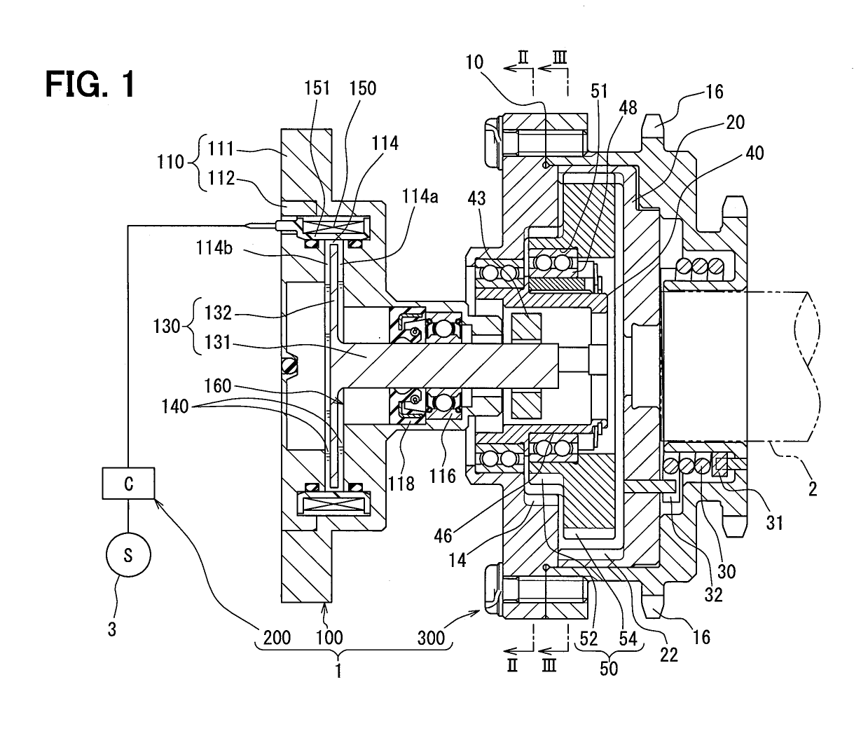

As shown in FIG. 1, a valve timing controller 1 includes a fluid brake device 100. The valve timing controller 1 is mounted to a transmission system that transmits an engine torque from a crankshaft (not shown) to a camshaft 2 in an internal combustion engine for a vehicle. The camshaft 2 opens or closes an intake valve (not shown) of the internal combustion engine through transmission of the engine torque. The valve timing controller 1 controls a valve timing of the intake valve.

The valve timing controller 1 includes a control circuit 200 and a phase adjusting mechanism 300 in addition to the fluid brake device 100. The valve timing controller 1 controls a relative rotational phase between the crankshaft and the camshaft 2 to realize a desired valve timing. The relative rotational phase between the crankshaft and the camshaft 2 may be referred as an engine phase.

As shown in FIG. 1, the fluid brake device 100 has a case 110, a brake rotor 130, a magnetorheological fluid 140 and a coil 150.

The case 110 has a fixed member 111 and a cover member 112, and is made hollow as a whole. The fixed member 111 has a cylindrical shape with a step part, and is made of magnetic material. The fixed member 111 is fixed to a stationary section (not shown) such as a chain case of the engine. The cover member 112 has a circular pan shape, and is made of magnetic material. The fixed member 111 is arranged between the phase adjusting mechanism 300 and the cover member 112 in an axis direction. The cover member 112 is liquid-tightly fitted into the fixed member 111. A space between the fixed member 111 and the cover member 112 is defined as a fluid chamber 114 which is inside of the case 110.

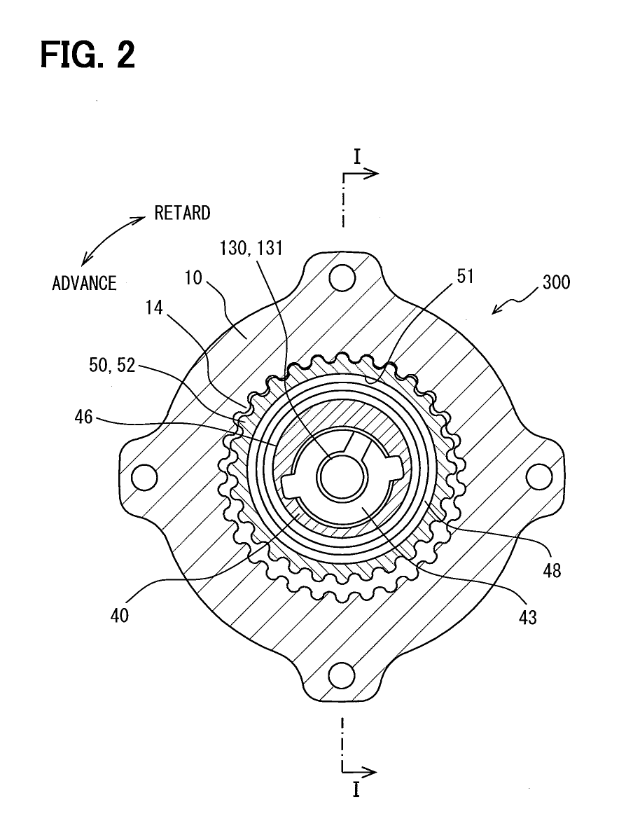

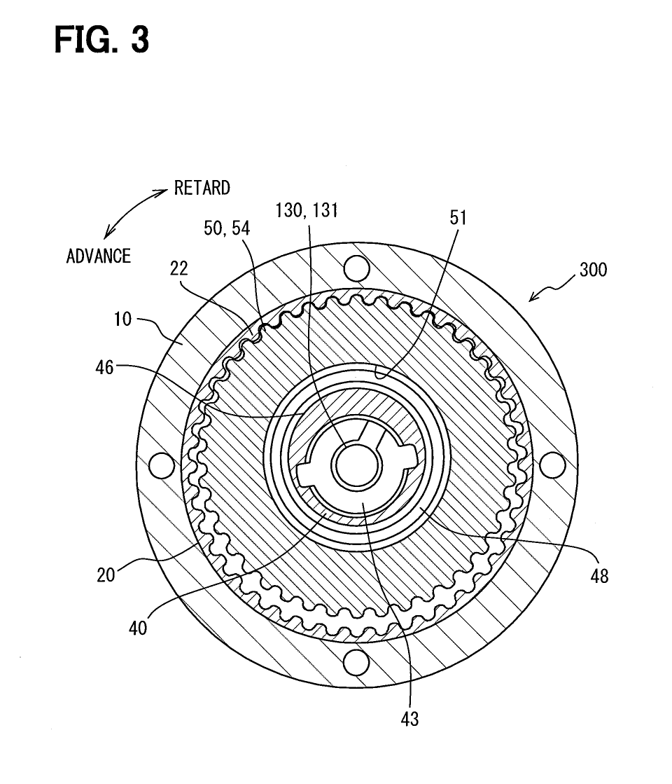

The brake rotor 130 has a shaft part 131 and a magnetic part 132. The shaft part 131 has a column shape made of metal, and is arranged to have the same axis as the fixed member 111 and the cover member 112 of the case 110. The shaft part 131 penetrates the fixed member 111, and has an end portion projected outward from the case 110 in the axis direction to be linked with the phase adjusting mechanism 300. A middle portion of the shaft part 131 in the axis direction is rotatably supported by a bearing 116 of the fixed member 111. An oil seal 118 seals a space between the shaft part 131 and the fixed member 111, and is located between the bearing 116 and the fluid chamber 114 in the axis direction. When the engine torque output from the crankshaft is transmitted to the brake rotor 130 from the phase adjusting mechanism 300, the brake rotor 130 rotates in a predetermined direction (counterclockwise direction in FIGS. 2 and 3).

As shown in FIG. 1, the magnetic part 132 has a ring board shape made of magnetic material, and is accommodated in the fluid chamber 114. The magnetic part 132 projects from an axial end of the shaft part 131 in the radial direction. The fluid chamber 114 has a first magnetism gap 114a and a second magnetism gap 114b. The first magnetism gap 114a is defined between the magnetic part 132 and the fixed member 111 in the axis direction, and the second magnetism gap 114b is defined between the magnetic part 132 and the cover member 112 in the axis direction. That is, the magnetic part 132 is located between the first magnetism gap 114a and the second magnetism gap 114b in the axis direction.

The magnetorheological fluid 140 is enclosed in advance in the fluid chamber 114 having the gaps 114a, 114b. The magnetorheological fluid 140 is a kind of functional fluid in which magnetic particles are suspended in base liquid. The base liquid may be nonmagnetic fluid such as oil. The base liquid may be made of oil similar to lubrication oil for the engine. The magnetic particles may be magnetic powder such as carbonyl iron.

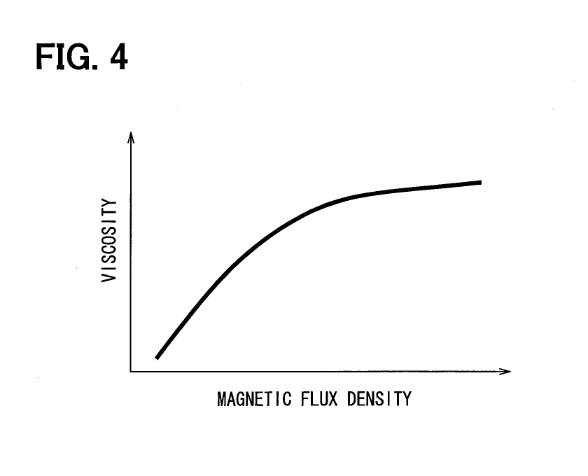

As shown in FIG. 4, apparent viscosity of the magnetorheological fluid 140 is raised as a density of magnetic flux passing through the magnetorheological fluid 140 is increased. Further, the shear yield stress also increases in proportion to the viscosity.

As shown in FIG. 1, the coil 150 has a bobbin 151 made of resin and a metal wire winded around the bobbin 151, and is coaxially arranged on the outer circumference side of the magnetic part 132. The coil 150 is held by the case 110 in the state where the coil 150 is interposed between the fixed member 111 and the cover member 112. When electricity is supplied to the coil 150, magnetic flux is generated and passes in order of the cover member 112, the second magnetism gap 114b, the magnetic part 132, the first magnetism gap 114a, and the fixed member 111.

Therefore, when the magnetic flux occurs while the engine is operated, the magnetic particles contained the magnetorheological fluid 140 are adsorbed by the magnetic part 132 and the case 110, which are in contact with the fluid 140. At this time, the viscosity of the fluid 140 is raised in the magnetism gaps 114a, 114b. Thus, the braking torque which brakes the magnetic part 132 is given to the brake rotor 130, which is rotating, in a reverse direction opposite from the rotation direction (clockwise direction in FIGS. 2 and 3).

As shown in FIG. 1, the phase adjusting mechanism 300 includes a driving rotor 10, a driven rotor 20, an assist member 30, a planetary carrier 40 and a planetary gear 50.

The driving rotor 10 has a cylindrical shape made of metal. A circumference wall part of the driving rotor 10 has a driving side internal-gear part 14 and plural sprocket teeth 16. The internal-gear part 14 has an addendum (tip) circle with diameter smaller than that of a root circle. The sprocket teeth 16 are projected outward in the radial direction. A timing chain (not shown) is arranged between the sprocket teeth 16 and teeth of the crankshaft, so that the driving rotor 10 is linked with the crankshaft. While the engine is operated, the engine torque output from the crankshaft is transmitted to the driving rotor 10, and the driving rotor 10 is interlocked with the crankshaft and rotates in the predetermined direction (counterclockwise direction in FIGS. 2 and 3).

The driven rotor 20 has a based cylindrical shape made of metal, and is coaxially arranged on the inner circumference side of the driving rotor 10. A circumference wall part of the driven rotor 20 has a driven side internal-gear part 22 having an addendum (tip) circle with diameter smaller than that of a root circle. A bottom wall part of the driven rotor 20 is coaxially linked with the camshaft 2, such that the driven rotor 20 rotates in the predetermined direction (counterclockwise direction in FIGS. 2 and 3) together with the camshaft 2 and that the driven rotor 20 relatively rotates relative to the driving rotor 10 while the internal combustion engine is operated.

As shown in FIG. 1, the assist member 30 is coaxially arranged on the inner circumference side of the driving rotor 10, and is made of metal torsion coil spring. The assist member 30 has a first end 31 engaged with the driving rotor 10 and a second end 32 engaged with the driven rotor 20. The assist member 30 biases the driven rotor 20 on the retard side relative to the driving rotor 10 by being twistingly deformed between the first end 31 and the second end 32.

The planetary carrier 40 has a cylindrical shape made of metal, and is coaxially coordinated with the shaft part 131 of the brake rotor 130 through a joint 43, such that the planetary carrier 40 rotates in the predetermined direction (counterclockwise direction in FIGS. 2 and 3) together with the brake rotor 130 and that the planetary carrier 40 relatively rotates relative to the driving rotor 10 while the internal combustion engine is operated.

A circumference wall part of the planetary carrier 40 has a supporting portion 46 which supports the planetary gear 50. The supporting portion 46 is a bearing having cylindrical surface, and is eccentrically arranged with respect to the rotors 10, 20 and the shaft part 131. The supporting portion 46 is coaxially fitted into a center hole 51 of the planetary gear 50 through a planetary bearing 48. The planetary gear 50 is supported by the supporting portion 46 in such a manner to perform the planetary motion. Specifically, the planetary gear 50 rotates about an eccentric axis of the supporting portion 46 with respect to the shaft part 131, and also the planetary gear 50 revolves relative to the planetary carrier 40. Thus, when the planetary carrier 40 performs relative rotation with respect to the driving rotor 10 in the revolution direction of the planetary gear 50, the planetary gear 50 performs the planetary motion.

The planetary gear 50 has a cylindrical shape with a step part, and is made of metal. A circumference wall part of the planetary gear 50 has an external-gear part 52, 54 having an addendum (tip) circle with diameter larger than that of a root circle. The driving side external-gear part 52 is arranged on the inner circumference side of the driving side internal-gear part 14, and engages with the driving side internal-gear part 14. The driven side external-gear part 54 is arranged on the inner circumference side of the driven side internal-gear part 22, and engages with the driven side internal-gear part 22.

The phase adjusting mechanism 300 controls the engine phase according to the braking torque input into the brake rotor 130 and the assist torque of the assist member 30 acting on the brake rotor 130 in a reverse direction opposite from the braking torque. Specifically, when the brake rotor 130 rotates with the same speed as the driving rotor 10 by holding the braking torque, the planetary carrier 40 does not carry out relative rotation relative to the driving rotor 10. As a result, because the planetary gear 50 rotates with the rotors 10 and 20 without carrying out the planetary motion, the engine phase is held.

On the other hand, when the brake rotor 130 rotates with a speed slower than that of the driving rotor 10 against the assist torque according to increase in the braking torque, the planetary carrier 40 carries out relative rotation on the retard side relative to the driving rotor 10. As a result, because the planetary gear 50 carries out the planetary motion and because the driven rotor 20 carries out relative rotation on the advance side relative to the driving rotor 10, the engine phase is advanced.

Moreover, when the brake rotor 130 rotates with a speed higher than that of the driving rotor 10 in response to the assist torque caused by decrease in the braking torque, the planetary carrier 40 carries out relative rotation on the advance side relative to the driving rotor 10. As a result, because the planetary gear 50 carries out the planetary motion and because the driven rotor 20 carries out relative rotation on the retard side relative to the driving rotor 10, the engine phase is retarded.

The control circuit 200 is mainly constructed by a microcomputer, and is arranged outside of the fluid brake device 100. The control circuit 200 is electrically connected with a variety of components of the engine such as a starter 3 that drives the engine and the coil 150 of the fluid brake device 100. The control circuit 200 controls the engine by giving a control command to the components such as the starter 3. Moreover, the control circuit 200 carries out variable control of the viscosity of the magnetorheological fluid 140 by controlling the current supplied to the coil 150 while the engine is operated. The braking torque input into the brake rotor 130 is changed in response to the current supplied to the coil 150, such that the engine phase is controlled by the phase adjusting mechanism 300.

The control circuit 200 sequentially executes a startup mode and a usual mode as control mode while the engine is operated.

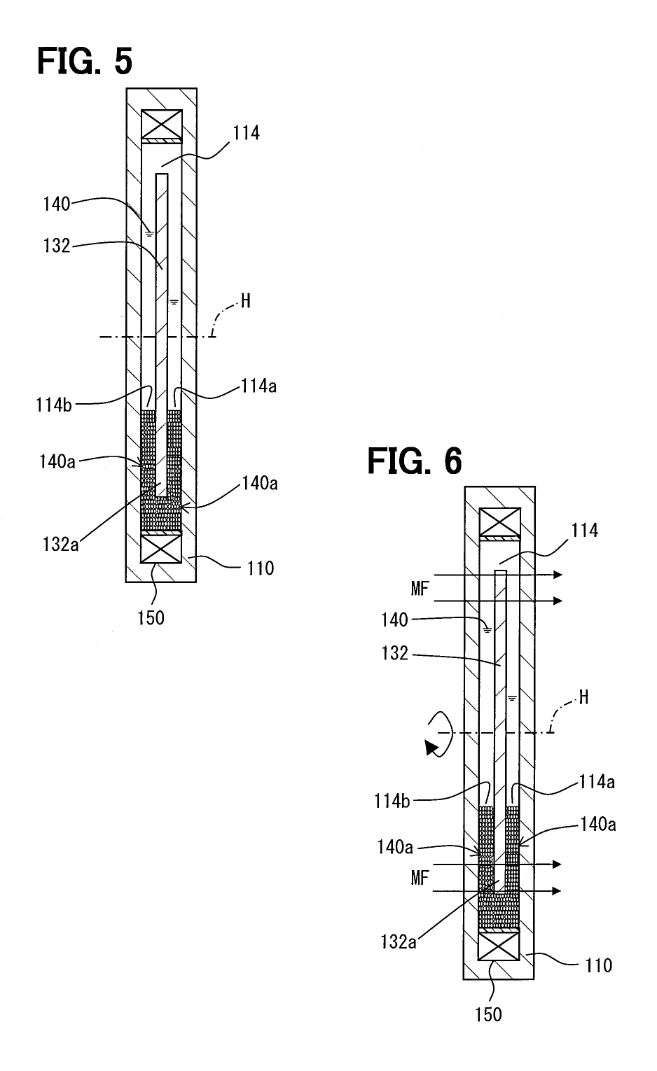

The startup mode is performed at the startup time of the engine. In other words, the startup mode is started when the phase adjusting mechanism 300, the camshaft 2, and the brake rotor 130 start rotating with the crankshaft. Before the startup mode, the magnetic part 132 of the brake rotor 130 is in the stop state as shown in FIG. 5. In the startup mode, the control circuit 200 starts supplying electricity to the coil 150 with cranking by the starter 3. Thus, as shown in FIG. 6, the magnetic flux MF passes through the fluid 140 in the magnetism gaps 114a and 114b, and the magnetic flux MF passes through the magnetic part 132 and the case 110 which contact the fluid 140.

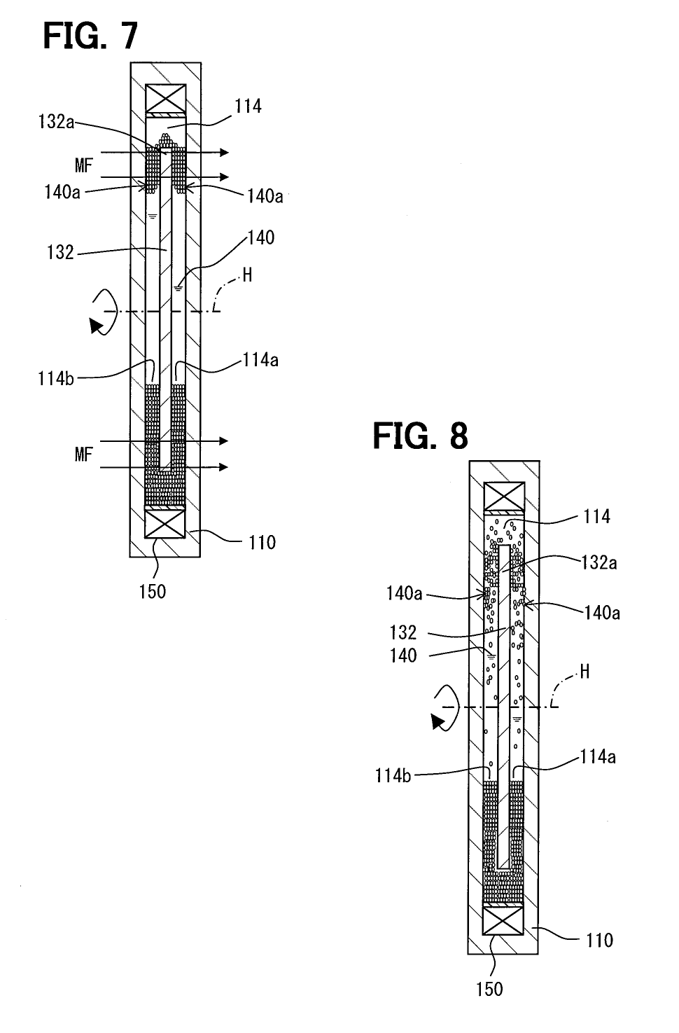

Furthermore, in the startup mode, the control circuit 200 continuously supplies electricity to the coil 150 until a lowest section 132a of the magnetic part 132 has a half rotation from the lowest position of FIG. 5 to the highest position of FIG. 7. In FIG. 5, the magnetic part 132 is stopped and the lowest section 132a is located between the magnetism gaps 114a and 114b. In FIG. 7, the magnetic part 132 rotates around a horizontal line H, and the lowest section 132a arrives at the highest position after the half rotation. That is, at the startup mode, the control circuit 200 stops supplying the electricity to the coil 150 when the lowest section 132a of the magnetic part 132 finishes the half rotation upward. At this time, as shown in FIG. 8, the magnetic flux MF is made disappear.

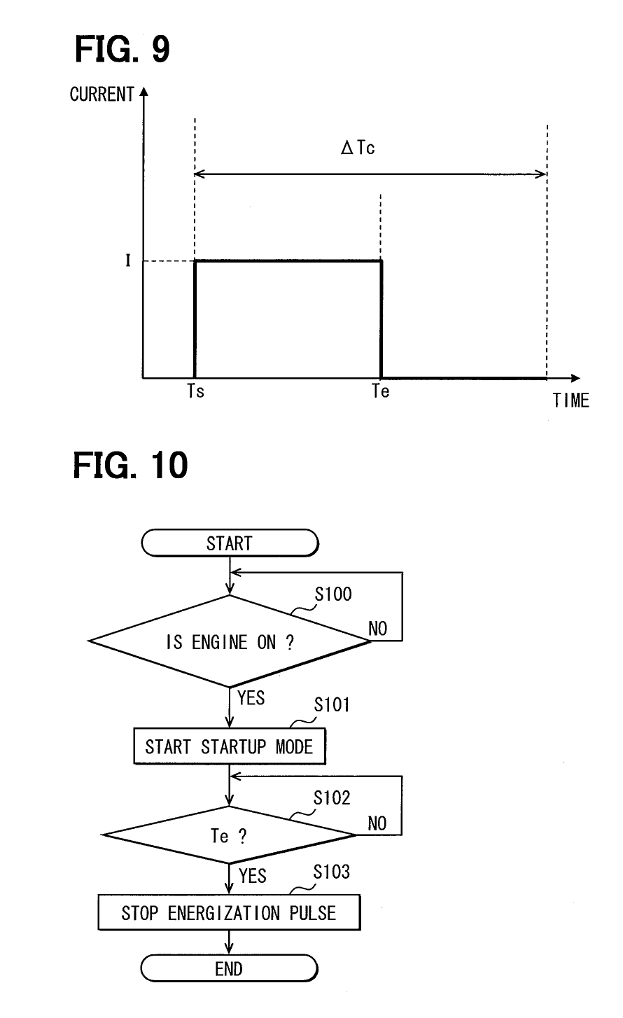

In order to realize the above control, the control circuit 200 impresses an energization pulse wave shown in FIG. 9 to the coil 150. The pulse wave has a constant current I, and is applied from a start timing Ts to a finish timing Te. A period ΔTc in FIG. 9 represents a startup period of the engine. The pulse wave is applied for a predetermined pulse period from the start timing Ts to the finish timing Te.

The finish timing Te, at which the pulse wave is stopped, is determined in advance by predicting based on the rotation number of the crankshaft which has tendency to gradually increase from the start of the cranking. The constant current I of the pulse wave is controlled in consideration of the predetermined pulse period in a manner that the engine phase is adjusted within an allowable range which allows the start of the engine by inputting the braking torque into the phase adjusting mechanism 300.

The normal mode is executed immediately after the startup mode, at or immediately after the startup of the engine, so the normal mode may be started within or after the period ΔTc. In the normal mode, the control circuit 200 sequentially determines a target engine phase so that the valve timing is made suitable for the operation condition of the combustion engine. Further, when the target phase is determined, the control circuit 200 supplies electricity to the coil 150 in a manner that the braking torque is generated to control the engine phase to agree with the target phase.

A control flow executed by the control circuit 200 to perform the startup mode is explained based on FIG. 10. The control flow is started when a predetermined condition is satisfied in advance of the startup of the engine. For example, the control flow is started when a door of the vehicle is unlocked, when a door of the vehicle is opened, or when a receiver receives a signal from a transmitter of a keyless entry system of the vehicle.

In S100, it is determined whether the engine switch is turned on to activate the engine. If the engine switch is kept off, S100 is repeatedly performed. If it is determined that the engine switch is turned on, the control flow shifts to S101.

In S101, the startup mode is started, and the pulse wave having the constant current I is applied to the coil 150. Further, a timer for measuring elapsed time is started.

In S102, it is determined whether the elapsed time measured by the timer meets the finish timing Te after the predetermined pulse period passes from the start timing Ts. If the timing is before the finish timing Te, S102 is repeatedly performed, so the pulse wave is continuously applied to the coil 150. If it is determined that the timing meets or passes the finish timing Te, the control flow shifts to S103, and the impression of the pulse wave to the coil 150 is stopped. Thus, the startup mode is completed when the control flow is ended.

According to the embodiment, at the startup of the combustion engine, when the brake rotor 130 having the magnetic part 132 in contact with the magnetorheological fluid 140 starts rotating, electricity is supplied to the coil 150, and the magnetic flux MF generated by the coil 150 passes through the magnetorheological fluid 140 and the magnetic part 132. Therefore, magnetic particles 140a which stay in the lower area of the magnetorheological fluid 140 shown in FIG. 5 can be adsorbed to at least the lowest section 132a of the magnetic part 132 due to the magnetic flux MF generated by the coil 150, as shown in FIG. 6.

The electricity supplied to the coil 150 is continued before the lowest section 132a carries out a half rotation upward, as shown in FIG. 7. Therefore, the magnetic particles 140a adsorbed to the lowest section 132a are moved in the rotation direction to the highest position corresponding to the half rotation.

The electricity supplied to the coil 150 is stopped at the finish timing Te at which the lowest section 132a finishes the half rotation, so the magnetic flux MF passing through the magnetorheological fluid 140 and the magnetic part 132 disappears, as shown in FIG. 8. Because the magnetic flux MF disappears, the magnetic particles 140a located at the highest position fall downward due to gravity force. Therefore, the magnetic particles 140a are dispersed in the rotation direction due to the flow action of the magnetorheological fluid 140 around the magnetic part 132 which is rotating.

According to the embodiment, the magnetic particles 140a can be uniformly distributed in the rotation direction and can be adsorbed to the magnetic part 132 at or immediately after the startup of the engine. Therefore, the braking torque given to the brake rotor 130 is stabilized, and the brake performance can be restricted from being varied. Moreover, the control accuracy of the engine phase can be raised because the braking torque, which is input from the fluid brake device 100 to the phase adjusting mechanism 300, is stabilized. Thus, the engine phase can be accurately controlled within the allowable range, even if the braking torque generated by supplying electricity to the coil 150 is input into the phase adjusting mechanism 300 at the startup of the engine in order to improve the dispersibility (to make density uniform) of the magnetic particles 140a.

Moreover, at the startup time, the electricity supplied to the coil 150 is continued until the lowest section 132a of the magnetic part 132 finishes a half rotation in the state where the lowest section 132a is interposed between the magnetism gaps 114a and 114b in the axis direction. Therefore, the magnetic particles 140a can move upward in the rotation direction due to the magnetism gaps 114a and 114b, and can be made to fall downward by the gravity force, as shown in FIG. 8. Thus, at or immediately after the startup time, the dispersibility of the magnetic particles 140a which are adsorbed to the magnetic part 132 can be raised in the rotation direction, on the both sides of the magnetic part 132 in the axis direction. Therefore, stable and large braking torque can be given to the brake rotor 130, and a variation in the brake performance can be reduced.

Furthermore, the electricity supplied to the coil 150 is limited to the predetermined pulse period during which the magnetic part 132 carries out the half rotation by setting the finish timing Te which stops the electricity supplied to the coil 150. Therefore, the engine phase can be kept in the allowable phase range because the braking torque is generated in the limited period for distributing the magnetic particles 140a.

Moreover, the finish timing Te is predicted based on the rotation number of the crankshaft at the startup time of the engine. Therefore, the engine phase can be accurately controlled within the allowable phase range even if the braking torque is generated by supplying the electricity. Thus, even at the startup time in which the rotation number of the crankshaft and the rotation number of the magnetic part 132 are low, the engine phase can be kept in the allowable phase range without detecting the rotation numbers.

The present disclosure should not be limited to the embodiment, but may be implemented in other ways.

The electricity supplied to the coil 150 may be continued after the finish timing Te. Moreover, the finish timing Te at which the electricity supplied to the coil 150 is stopped may be determined based on the actually-detected rotation number of the crankshaft, the camshaft, or the brake rotor 130 instead of predicting the rotation number of the crankshaft.

The present disclosure is applicable also to a valve timing controller which controls a valve timing of an exhaust valve, and a valve timing controller which controls valve timings of both the intake valve and the exhaust valve. The present disclosure is applicable to various kinds of device using braking torque.

Such changes and modifications are to be understood as being within the scope of the present disclosure as defined by the appended claims.

What is claimed is:

1. A fluid brake device comprising:
a coil that generates magnetic flux by being supplied with electricity,
a magnetorheological fluid, in which magnetic particles are suspended, has a viscosity that is varied by the magnetic flux passing through the magnetorheological fluid;
a case defining a fluid chamber that is filled with the magnetorheological fluid;
a brake rotor having a magnetic part received in the fluid chamber, the magnetic flux passing through the magnetic part, the brake rotor receiving a braking torque in accordance with a variation in the viscosity of the magnetorheological fluid that contacts the magnetic part while the brake rotor rotates; and
a controller that controls the electricity supplied to the coil, wherein the controller continues supplying the electricity to the coil while the brake rotor has a half rotation from a stop state where the brake rotor is stopped at a startup time at which the brake rotor starts rotating.

2. The fluid brake device according to claim 1, wherein
the magnetic part has a lowest section in a vertical direction when the magnetic part is in the stop state,
the lowest section of the magnetic part rotates upward by the half rotation at the startup time, and
the controller stops the electricity supplied to the coil at a finish timing at which the lowest section of the magnetic part finishes the half rotation.

3. The fluid brake device according to claim 2, wherein
the fluid chamber defines a first magnetism gap and a second magnetism gap in a manner that the magnetic part is located between the first magnetism gap and the second magnetism gap in an axis direction,
the magnetic flux generated by the coil passes through the first magnetism gap and the second magnetism gap, and
the controller continues supplying the electricity to the coil while the lowest section that is located between the first magnetism gap and the second magnetism gap has the half rotation.

4. A valve timing controller that controls a valve timing of a valve opened and closed by a torque transmitted from a crankshaft to a camshaft of an internal combustion engine, the valve timing controller comprising: the fluid brake device according to claim 1; and a phase adjusting mechanism connected to the brake rotor, wherein
the phase adjusting mechanism controls a relative rotational phase between the crankshaft and the camshaft according to the braking torque input into the brake rotor, and
the controller of the fluid brake device controls the electricity supplied to the coil in a manner that the relative rotation phase is controlled within a predetermined allowable phase range which allows a startup of the internal combustion engine when the brake rotor starts rotating together with the crankshaft and the camshaft.

5. The valve timing controller according to claim 4, wherein
the magnetic part has a lowest section in a vertical direction when the magnetic part is in the stop state,
the lowest section of the magnetic part rotates upward by the half rotation when the brake rotor starts rotating together with the crankshaft and the camshaft, and
the controller stops the electricity supplied to the coil at a finish timing at which the lowest section of the magnetic part finishes the half rotation.

6. The valve timing controller according to claim 5, wherein
the finish timing is set by predicting a rotation number of the crankshaft at a startup time of the internal combustion engine when the brake rotor starts rotating together with the crankshaft and the camshaft.
